(19) United States
(12) Patent Application Publication
(10) Pub. No.: US 2007/0019500 A1
(43) Pub. Date: Jan. 25, 2007

(54) Screw type extruder

(75) Inventors: Junichi Iwai, Hiroshima-shi (JP); Nobuaki Shimizu, Hiroshima-shi (JP)

Correspondence Address: SUGHRUE MION, PLLC, 2100 PENNSYLVANIA AVENUE, N.W., SUITE 800, WASHINGTON, DC, 20037, US

(73) Assignee: THE JAPAN STEEL WORKS, LTD.

(21) Appl. No.: 11/489,479

(22) Filed: Jul. 20, 2006

(30) Foreign Application Priority Data
Jul. 21, 2005 (JP) P2005-210954

(51) Int. Cl. B28B 17/02

(52) U.S. Cl. 366/100

(57) ABSTRACT

A screw type extruder comprises an extruder body including a screw and a cylinder having the screw rotatably inserted therein, and a superconducting motor connected to the rear end of the extruder body for driving the screw rotatably, wherein no reduction mechanism is interposed between the screw and the superconducting motor.

This application is based on Japanese patent application No. 2005-210954, which is incorporated herein by reference.

### BACKGROUND OF THE INVENTION

1. Field of the Invention

The present invention relates to a screw type extruder and, more particularly, to novel improvements for driving screws rotationally by means of a superconducting motor without using any reduction means.

2. Description of the Related Art

Generally, a synthetic resin material is melted and blended by a screw type extruder with a view to modifying the material made by a synthesizing reaction, improving physical properties or functionalities, or molding the material, and is granulated into pellets or extruded into a sheet or film shape. The screw type extruder is constituted, although not shown, to comprise: an extruder body including an elongated cylindrical screw having a helical screw groove in its outer circumference, and a cylinder having the screw rotatably inserted therein; a drive unit or a gear mechanism connected to the rear end of the extruder body for driving the screw rotationally; and a drive motor connected to the rear end of the drive unit. The extruder body is called the “single axis”, in case a single screw is inserted in the cylinder, the “two axes”, in the case of two screws, and the “multiple axes” in the case of more screws. In the multiple-axis case, the distributor is interposed between the extruder body and the drive unit so that the rotatable screws can be individually driven. Usually, the distributor and the drive unit are integrated. The granulating device or the sheet or film molding device is connected to the leading end of the extruder body.

In the screw type extruder thus constituted, due to the high load of the extruder, the drive unit and the drive motor become so larger than the extruder body that they need a large mounting space. Moreover, the drive unit and the drive motor have large noises at the driving time, so that they cannot provide satisfactory working environments. Accordingly, several improvements have been made for this screw type extruder. On the multi-axis screw type extruder, the drive unit is reduced in size by using a planetary gear type (JP-A-11-115035). On the single-axis screw type extruder, on the other hand, the size is reduced by omitting the drive unit and by driving the screw directly with the drive motor (JP-A-2002-067123 and JP-A-2003-103597). Moreover, the driving force is intensified by connecting a plurality of drive motors in tandem (JP-A-2003-103597).

The screw type extruder of the related art having the constitutions described above has the following problems.

Substantial improvements have never been made on the size reduction of the drive motor for the necessary driving force and on the decrease in the running noises. In the aforementioned individual constitutions of the related art, large motors and reduction mechanisms are required for bearing the loads of the extruder, so that the noises at the running time deteriorate the environments drastically.

### SUMMARY OF THE INVENTION

The invention has been conceived to solve the problems thus far described, and has an object to provide a screw type extruder, which is enabled to reduce the running noises by using a superconducting motor to drive screws rotationally without any reduction mechanism.

According to the invention, there is provided a screw type extruder comprising: an extruder body including a screw and a cylinder having the screw rotatably inserted therein; and a superconducting motor connected to the rear end of the extruder body for driving the screw rotatably, wherein the screw and the superconducting motor are connected without interposing a reduction mechanism therebetween.

The screw type extruder of the invention has the constitutions described above so that it can have the following effects.

Specifically, the screw type extruder comprises: the extruder body including the screw and the cylinder having the screw rotatably inserted therein; and the superconducting motor connected to the rear end of the extruder body for driving the screw rotatably, and the screw type extruder does not use any reduction mechanism. As a result, the drive motor can be small-sized to reduce its mounting space. Moreover, the superconducting motor has a higher efficiency than that of the related motor, and has less noise accompanied by whine so that the extruder itself can reduce the noises.

Since the superconducting motor is a liquid-nitrogen high-temperature full superconducting motor, it uses liquid nitrogen as the coolant, so the cost is kept low on coolant. Because of the full superconductivity, the field coils and the armature coils are made superconductive and fixed so that a plurality of motors can be connected in tandem and so that an easy correspondence can be made to the change in the driving force required.

### BRIEF DESCRIPTION OF THE DRAWING

FIG. 1 is a constitution diagram showing a screw type extruder according to the invention.

### DETAILED DESCRIPTION OF THE PREFERRED EMBODIMENTS

An object of the invention is to provide a screw type extruder which is enabled to drive screws in low noises, in a small size and without any cooling system, by using a superconducting motor as its drive motor but without any reduction means.

### Embodiment

A preferred embodiment of the screw type extruder according to the invention is described in the following with reference to the accompanying drawing.

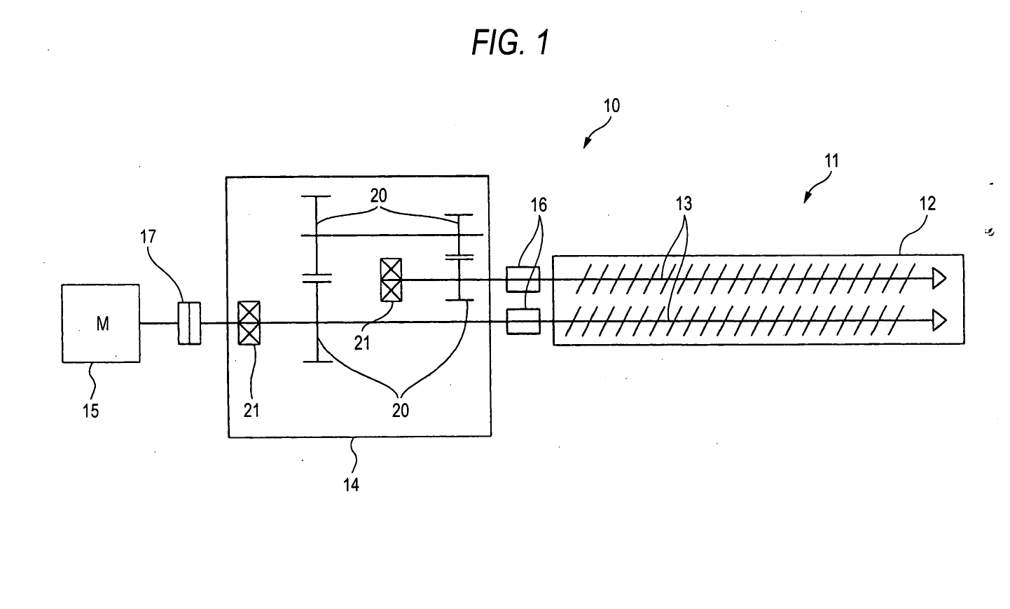

FIG. 1 is a constitution diagram showing the screw type extruder according to the invention. In FIG. 1, numeral 10 designates the screw type extruder. This screw type extruder 10 is constituted such that an extruder body 11 having two parallel screws 13 inserted and rotationally driven in a cylinder 12, a distributor 14 and a superconducting motor 15 are arranged in series. The extruder body 11 and the distributor 14 are connected by a pair of connectors 16, and the distributor 14 and the superconducting motor 15 are connected by a coupler 17. The distributor 14 is composed of plural gears 20 and plural bearings 21 but not equipped with any reduction means. As a result, the rotations of the superconducting motor 15 are transmitted to the individual screws without any reduction.

Although not shown: a control device and a lubrication device are connected to the screw type extruder 10; the power source device is connected with the superconducting motor 15; the material supply device is connected with the trailing end portion of the cylinder 12; and the granulating device or the molding device is connected to the leading end portion of the cylinder 12.

The superconducting motor 15 is preferably exemplified by a liquid-nitrogen-cooled high-temperature full superconducting motor (manufactured by Ishikawajima Harima Jukogyo Kabushiki Gaisha), and has the following features.

(1) The field coils and the armature coils of the motor, that is, all the coils are made so superconductive that the motor liberates no heat. As a result, the motor requires no cooling device and space for it.

(2) All the coils are fixed to make unnecessary the coolant introduction or power supply from the rotating shafts, although they are needed in the superconducting motor of the related art. As a result, the coolant rotary joints or slip rings for the rotary members are not needed to reduce the important safety parts thereby to lower the safety loads. Moreover, the rotating shaft ends can be utilized to connect the plural motors in tandem.

(3) The motor can be reduced in size and in weight, as compared with the motor of the related art. In the case of 5,000 KW, the volume is reduced to about 1/10, and the weight is reduced to about ⅕. As a result, the area for installing the entire screw type extruder 10 is reduced in addition to the aforementioned item (1).

(4) The motor causes low whine and leaks little magnetic flux.

(5) The coolant is liquid nitrogen, which is easy to handle and inexpensive.

The screw type extruder 10 thus constituted is driven in the following manners. The not-shown control device and the lubrication device are activated to bring the screw type extruder 10 into the operable state. The superconducting motor 15 drives, when started, the input shaft of the distributor 14 through the coupler 17. In this distributor 14, the two output shafts are rotationally driven by the plural gears 20 and bearings 21 properly combined, so that the two screws 13 of the extruder body 11 are rotationally driven through the connectors 16. In the extruder body 11 having the two screws 13 rotationally driven, the synthetic resin material and the admixture, as added if necessary, are continuously fed from the material feeding device. The synthetic resin material and so on are sequentially molten and blended by the rotationally driven screws 13 and are fed toward the leading end so that they are continuously extruded through the granulating device or the molding device from the leading end of the cylinder 12.

Next, the noises and the energy efficiencies are compared in the following between the screw type extruder 10 shown in FIG. 1 and the related screw type extruder having a drive unit.

Noises:

Invention: Motor 20 to 30 dbA+Gear Mechanism 60 to 70 dbA=60 to 70 dbA

Related Art: Motor 85 dbA or more+Gear Mechanism 85 dbA or more=90 dbA or more

Energy Efficiencies:

Invention: Motor 99%+Gear Mechanism 98%

Related Art: Motor 90%+Gear Mechanism 96%

FIG. 1 shows the extruder body 11 of the two-axis case, in which the two screws 13 are so fitted in the cylinder 12 as can be rotationally driven. The use of the superconducting motor 15 as the drive motor can be likewise applied without any problem to the single case of the single screw 13 or to the multiple case of three or more axes. In the single-axis case, the distributor 14 is eliminated, and the rear end portion of the screw 13 of the extruder body 11 and the output shaft end portion of the superconducting motor 15 are connected through the connector 16. In the multiple case of three or more axes, on the other hand, the distributor 14 is equipped with output shafts of the same number as that of the screws 13 of the extruder body 11, so that the individual rear end portions of the screws 13 of the extruder body 11 and the individual output shaft end portions of the distributor 14 are connected by the connectors 16.

One or more new high-temperature full superconducting motors of the additional driving force can be connected in tandem on the opposite side of the extruder body 11 of the existing high-temperature full superconducting motor 15, if higher driving force is required due to the changes made to the conditions of use of the screw type extruder 10, i.e. the kinds or physical properties of the synthetic resin materials to be processed or the required throughput.

What is claimed is:

1. A screw type extruder comprising:
an extruder body including a screw and a cylinder having the screw rotatably inserted therein; and
a superconducting motor connected to a rear end of the extruder body for driving the screw rotatably,
wherein the screw and the superconducting motor are connected without interposing a reduction mechanism therebetween.

2. The screw type extruder according to claim 1, wherein at least two of the screws and the superconducting motor are connected through a distributor having a plurality of gears.

3. The screw type extruder according to claim 1, wherein the superconducting motor is a liquid-nitrogen-cooled high-temperature full superconducting motor.
